(19) United States
(12) Patent Application Publication
(10) Pub. No.: US 2026/0237178 A1
(43) Pub. Date: Aug. 13, 2026

(54) Object Recognition Device, Object Recognition Method, and Transfer Robot System

(71) Applicant: Hitachi, Ltd., Chiyoda-ku, Tokyo (JP)

(72) Inventors: Kento SEKIYA, Tokyo (JP); Taiki YANO, Tokyo (JP)

(21) Appl. No.: 19/154,437

(22) PCT Filed: Mar. 19, 2024
(86) PCT No.: PCT/JP2024/010653

§ 371 Date: Aug. 7, 2025

(30) Foreign Application Priority Data
Apr. 21, 2023 (JP) 2023-070149

(51) Int. Cl. G06V 10/25; B25J 9/16; G06T 7/73; G06V 10/75; G06V 10/764; G06V 20/50

(52) U.S. Cl. CPC G06V 10/25; B25J 9/1697; G06T 7/73; G06V 10/759; G06V 10/764; G06V 20/50; G06V 2201/06

(57) ABSTRACT

Provided are an object recognition device, an object recognition method, and a conveyance robot system with which it is possible to accurately identify an article even when there are different articles on the same pallet, by evaluating whether a detected article area coincides with an actual article area. An object recognition device according to the present invention, for example, recognizes an article area in an image captured by a camera, the object recognition device comprising: an input unit that acquires the image; a detection unit that detects an article area in the image and acquires position and posture information of an article; an identification unit that identifies an article type of the article area using a color feature or a shape feature of the article area; a certainty level calculation unit that compares the article types of adjacent article areas and calculates a certainty level representing the accuracy of detection of the article area; and an output unit that outputs, to a robot, an operation command based on the position and posture information of the article and the certainty level.

### TECHNICAL FIELD

This invention relates to an object recognition device, an object recognition method, and a transfer robot system.

### BACKGROUND ART

In recent distribution warehouses, robots such as an articulated arm robot for conveying articles have been widely used. For example, when this type of robot selects one of articles mixed on a pallet (hereinafter abbreviated as “mixed articles”) and conveys the article, it is necessary to correctly recognize the boundary between the article to be conveyed and other articles.

As a conventional technique in which a region including an object is detected from an image, an image processing device according to Patent Literature 1 is known. For example, the abstract of Patent Literature 1 describes a problem that “To provide a technique for accurately identifying variations of a product which has various variations”. As a solution, the abstract describes “An image processing device includes an object detection unit, a category identification unit, a product identification unit, and a display processing unit. The object detection unit detects a region including an object in an image. The category identification unit identifies the category to which the object belongs by using the shape of the detected region. The product identification unit identifies a product on the basis of reference data on the product corresponding to the identified category and a feature amount obtained from the region”.

Specifically, paragraph [0016] of Patent Literature 1 describes “the product identification unit 130 identifies an object (product) located in a region by performing matching processing between an image feature amount obtained from the region detected by the object detection unit 110 and reference data (reference image feature amount) on products prepared for product identification. . . . The product identification unit 130 narrows downs reference data on the product used for the matching processing with an image feature amount obtained from the region detected by the object detection unit 110, on the basis of the category of the object located in the region”.

In addition, regarding an identification error, paragraph [0053] of Patent Literature 1 describes “the identification-error-candidate extraction unit 150 may be configured to identify a candidate region on the basis of the confidence of matching processing (reliability of the product identification result) by the product identification unit 130. The confidence of matching processing can be determined, for example, on the basis of the magnitude of the score (similarity) obtained as the result of matching processing”.

### CITATION LIST

### Patent Literature

Patent Literature 1: Japanese Unexamined Patent Application Publication No. 2021-96635

### SUMMARY OF INVENTION

### Technical Problem

However, the image processing device of Patent Literature 1 only determines whether the image feature amount obtained from the region detected by the object detection unit 110 matches the reference data, and does not determine the accuracy of the detected region. Thus, there is a problem that when a region including an object is detected in a state in which articles having various patterns or shapes are mixed to overlap one another on a pallet, the image processing device of Patent Literature 1 performs matching processing even if the detected region is different from an actual article region. This may lead to erroneous identification of the articles.

Thus, an object of the present invention is to provide an object recognition device, an object recognition method, and a transfer robot system that can evaluate whether a detected article region and an actual article region are identical to each other, and accurately identify articles even when the articles are mixed on a pallet.

### Solution to Problem

In order to solve the above problems, an object recognition device of the present invention, for example, that recognizes an article region in an image captured by a camera, includes: an input unit that acquires the image; a detection unit that detects the article region in the image and acquires position/orientation information on an article; an identification unit that identifies an article type of the article region by using a color feature or a shape feature of the article region; a confidence calculation unit that compares the article types of the adjacent article regions and calculates confidence indicating accuracy of detection of the article region; and an output unit that outputs, to a robot, a motion command on the basis of the position/orientation information on the article and the confidence.

Further, an object recognition method of the present invention, for example, that recognizes an article region in an image captured by a camera, includes the steps of: acquiring the image; detecting the article region in the image and acquiring position/orientation information on an article; identifying an article type of the article region by using a color feature or a shape feature of the article region; and comparing the article types of the adjacent article regions and calculating confidence indicating accuracy of detection of the article region.

Further, a transfer robot system of the present invention including, for example, an object recognition device, a robot, and a camera, the object recognition device includes: an input unit that acquires an image captured by the camera; a detection unit that detects an article region in the image and acquires position/orientation information on an article; an identification unit that identifies an article type of the article region by using a color feature or a shape feature of the article region; a confidence calculation unit that compares the article types of the adjacent article regions and calculates confidence indicating accuracy of detection of the article region; and an output unit that outputs, to the robot, a motion command on the basis of the position/orientation information on the article and the confidence. The robot operates on the basis of the motion command.

### Advantageous Effects of Invention

According to the present invention, it is possible to evaluate whether a detected article region and an actual article region are identical to each other, and accurately identify articles even when the articles are mixed on a pallet.

### BRIEF DESCRIPTION OF DRAWINGS

FIG. 1 is an explanatory drawing showing the use environment of a transfer robot system according to a first embodiment.

FIG. 2 is a hardware configuration diagram of an object recognition device according to the first embodiment.

FIG. 3 is a functional block diagram of the object recognition device according to the first embodiment.

FIG. 4 is a flowchart showing processing performed by a calculation unit including a detection unit, an identification unit, and a confidence calculation unit.

FIG. 5A shows an example of the top view of an article including many flat surfaces on the top surface.

FIG. 5B shows an example of the top view of an article including many uneven portions on the top surface.

FIG. 5C shows an example of the top view of an article containing packaged bottles.

FIG. 6 shows an example in which an article is detected as two article regions of the same article type.

FIG. 7 shows an example in which an article is detected as two article regions of different article types.

FIG. 8 shows an example in which a flat article is detected as two article regions.

FIG. 9 shows an example in which an uneven article is detected as two article regions.

FIG. 10 shows an example in which a bottle package article is detected as two article regions.

FIG. 11 is a flowchart showing optimization of a recognition parameter according to a second embodiment.

FIG. 12A shows an example of an article arrangement before a slight displacement according to a third embodiment.

FIG. 12B shows an example of the article arrangement after the slight displacement according to the third embodiment.

FIG. 13 is a flowchart of the slight displacement according to the third embodiment.

### DESCRIPTION OF EMBODIMENTS

### First Embodiment

Hereinafter, embodiments of an object recognition device, an object recognition method, and a transfer robot system according to the present invention will be described in accordance with the accompanying drawings.

### <Outline of Transfer Robot System>

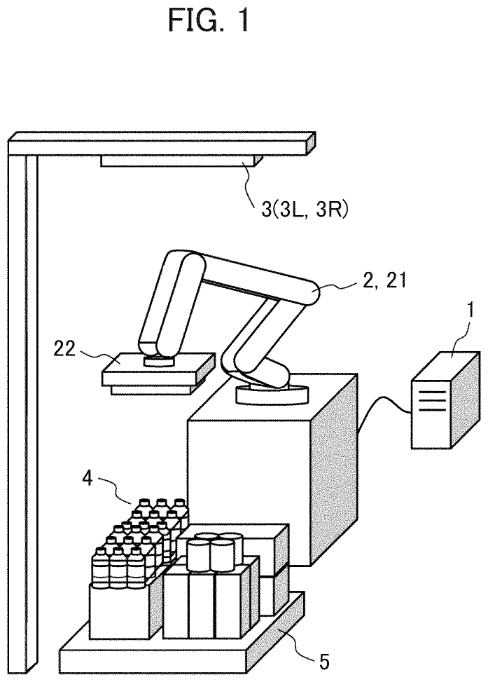

FIG. 1 is an explanatory drawing showing the use environment of a transfer robot system. An object recognition device 1 is connected to a robot 2 and outputs a motion command to the robot 2. In FIG. 1, the object recognition device 1 is connected to the robot 2 by wire. The connection is not limited thereto and may be a wireless connection. The robot 2 has an articulated arm 21 and a hand 22. The robot 2 is, for example, an articulated arm robot to be controlled by the object recognition device 1. A camera 3 is, for example, a stereo camera that captures an image with a left camera 3L and a right camera 3R operating in synchronization with each other and transmits a captured stereo image (hereinafter abbreviated as “image”) to the object recognition device 1. Articles 4 are various articles to be conveyed by the robot 2. The articles 4 include, for example, PET bottles, toilet rolls, and corrugated boards. A pallet 5 is a pallet on which the articles 4 are placed. The robot 2 is installed at a location where any of the articles 4 on the pallet 5 can be held with the hand 22 by moving the articulated arm 21. The camera 3 is installed at a location from which the overall top surface of the pallet 5 can be imaged. The object recognition device 1, the robot 2, and the camera 3 function as a transfer robot system.

### <Hardware Configuration of Object Recognition Device 1>

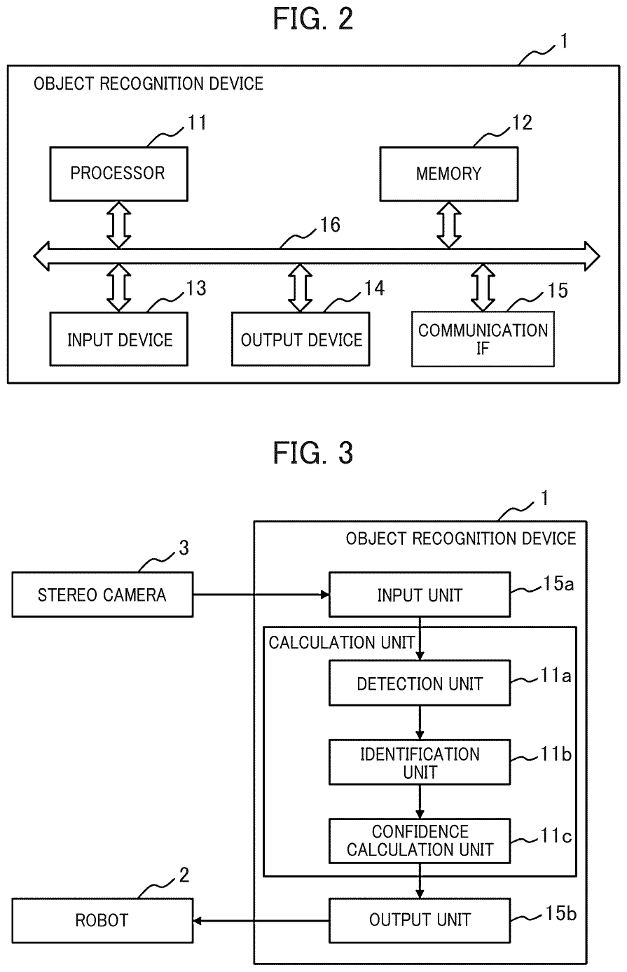

FIG. 2 is a hardware configuration diagram of the object recognition device 1. The object recognition device 1 is a computer including a processor 11 such as a CPU, a memory 12 such as a semiconductor memory, an input device 13 such as a keyboard or a mouse, an output device 14 such as a liquid crystal display, a communication interface 15 for communicating with the robot 2 and the camera 3, and a bus 16 connecting these components. The hardware configuration of the object recognition device 1 in FIG. 2 is merely an example and is not limited thereto.

### <Function Block of Object Recognition Device 1>

FIG. 3 is a functional block diagram of the object recognition device 1. The object recognition device 1 includes an input unit 15a that acquires an image captured by the camera 3 from above the articles 4 placed on the pallet 5, a detection unit 11a that detects an article region corresponding to the articles 4 in the acquired image, an identification unit 11b that identifies the article type of the detected article region, a confidence calculation unit 11c that compares the article types of adjacent article regions and calculates the confidence indicating the accuracy of detection of the article region, and an output unit 15b that outputs a motion command to the robot 2 on the basis of position/orientation information on the articles 4 and the confidence. The motion command is, for example, a command for holding the articles of an article region having high confidence. The detection unit 11a, the identification unit 11b, and the confidence calculation unit 11c function as a calculation unit. The calculation unit is implemented by the processor 11 shown in FIG. 2. The input unit 15a and the output unit 15b are function units implemented by the communication interface 15 shown in FIG. 2.

### <Outline of Flowchart of Processing in Calculation Unit>

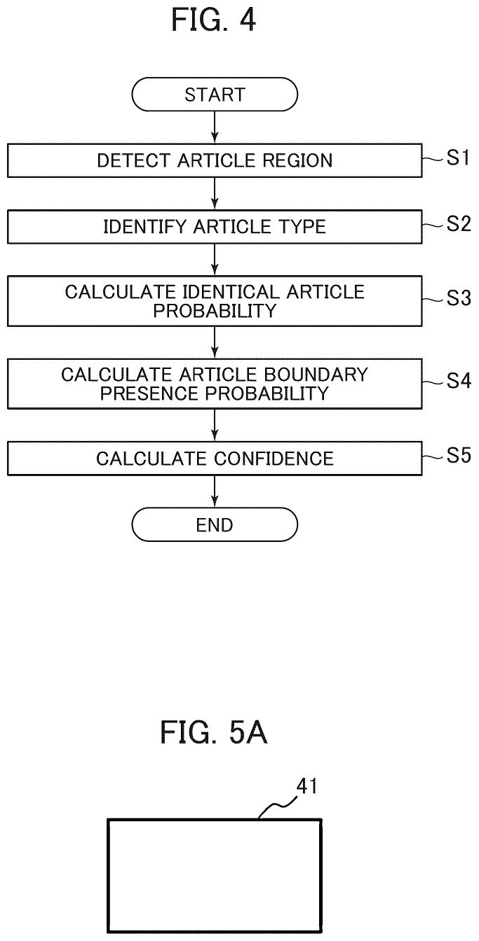

FIG. 4 is a flowchart showing processing performed by the calculation unit including the detection unit 11a, the identification unit 11b, and the confidence calculation unit 11c. The calculation unit performs Steps S1 to S5 shown in FIG. 4.

Hereinafter, the steps will be described in detail.

### <<Step S1>>

In Step S1, the detection unit 11a detects an article region corresponding to individual articles in an image and acquires position/orientation information on the articles. There are various methods for the detection unit 11a to detect the article region. For example, there is a method for obtaining shape features or color features in the image. Specifically, a method may be used in which vertical unevenness information included in the shape features is obtained from the image, recessed portions are detected as article boundaries between articles, and regions including many flat surfaces or regions including many uneven portions are detected as article regions. The unevenness information includes, for example, the curvature of the top surface of an article. The recessed portions include, for example, a portion having a large curvature. Alternatively, a method may be used with pattern matching between known shape features and color features of the image and the articles in top view. Note that the article region is a region where the articles are present in the image. In addition, the article boundary is the boundary between the article regions.

### <<Step S2>>

In Step S2, the identification unit 11b identifies the article type of the article region. The article type is identified using the shape feature or color feature of the article region in the image.

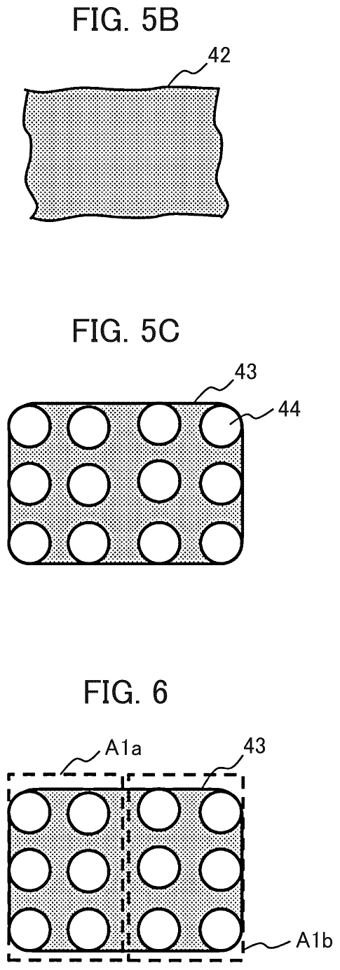

FIG. 5A shows an example of the top view of an article including many flat surfaces on the top surface. An article 41 in FIG. 5A is an article that includes many flat surfaces on the top surface of the article and only a few uneven portions in the vertical direction. On the basis of the shape feature of the article region in the image, the identification unit 11b identifies, as a flat article, the article type of a flat article region including only a few uneven portions on the top surface, for example, an article region corresponding to the article 41. For example, the article type of an article region corresponding to a corrugated cardboard or a box-shaped article is identified as a flat article.

FIG. 5B shows an example of the top view of an article including many uneven portions on the top surface. An article 42 in FIG. 5B is an article that includes many uneven portions on the top surface of the article, for example, an article having a large curvature on the top surface or an article having a nonlinear article boundary. On the basis of the shape feature of the article region in the image, the identification unit 11b identifies, as an uneven article, the article type of an article region including many uneven portions on the top surface, for example, an article region corresponding to the article 42. Furthermore, even in the case of box-shaped articles, the articles wrapped into a package may have a large curvature on the top surface. In this case, the articles are classified as an article including many uneven portions. For example, the article type of an article region corresponding to a toilet roll or an article in a bag is identified as an uneven article.

FIG. 5C shows an example of the top view of an article containing packaged bottles. An article 43 in FIG. 5C is a package of wrapped bottles. For example, the article contains beverage PET bottles. On the basis of the color feature of the article region in the image, the identification unit 11b identifies, as a bottle package article, the article type of an article region in which circular patterns corresponding to cap portions 44 at the tops of the bottles are arranged at equal intervals, for example, an article region corresponding to the article 43.

When an article is present with a shape or color feature different from the three article types in top view, the article may be added as a new type.

### <<Step S3>>

In Step S3 of FIG. 4, the confidence calculation unit 11c compares the article types of adjacent article regions and calculates, as identical article probability, the probability that the adjacent article regions contain the same article. Specifically, first, the confidence calculation unit 11c extracts a pair of adjacent article regions on the basis of article position/orientation information obtained by the detection unit 11a in Step S1. Thereafter, the article types of the adjacent article regions are compared with each other. When a combination of article types of adjacent article regions is identical to a combination preset as a combination of article types that are likely to contain the same article, the identical article probability is calculated to be higher than a predetermined value. For example, as will be described later, a combination of article types that are likely to include the same article may be a combination of the same article type or a combination of one of a flat article and an uneven article and a bottle package article.

FIG. 6 shows an example in which an article is detected as two article regions of the same article type.

Specifically, FIG. 6 shows an example in which the article 43 is detected as an article region A1a and an article region A1b. It is assumed that the article types of the article region A1a and the article region A1b are identified as the bottle package article on the basis of information about circular patterns in the article region A1a and the article region A1b.

When the adjacent article regions have the same article type like the article region A1a and the article region A1b shown in FIG. 6, the adjacent article regions are likely to contain the same article. Thus, the identical article probability is calculated to be higher than the predetermined value. In the present embodiment, the predetermined value is 50% but is not limited thereto. In the case of FIG. 6, the confidence calculation unit 11c calculates the identical article probability at 75%, which is higher than the predetermined value of 50%.

When the adjacent article regions have different article types, it is likely that the adjacent article regions basically represent different articles. Depending on a combination of article types of the adjacent article regions, it is likely that the adjacent article regions contain the same article. Thus, the identical article probability is calculated according to the combination of different article types.

For example, when a combination of different article types is a combination of a flat article and an uneven article, the adjacent article regions are likely to represent different articles. Thus, the identical article probability is calculated to be lower than the predetermined value. For example, the identical article probability is calculated as 25%, which is lower than the predetermined value of 50%.

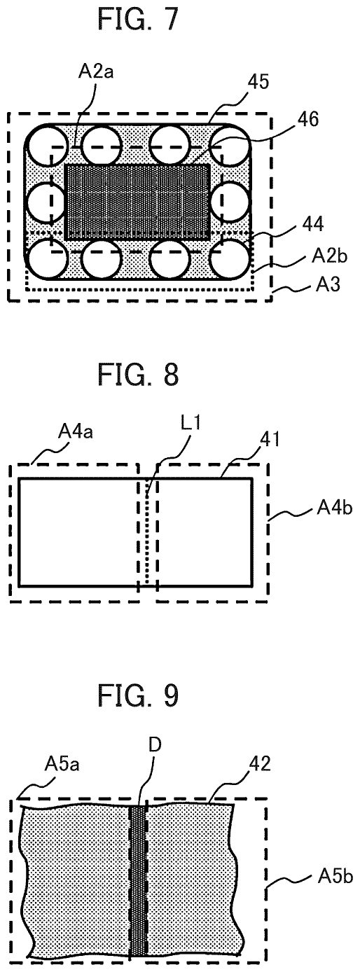

FIG. 7 shows an example in which an article is detected as two article regions of different article types. FIG. 7 is a top view of a labeled bottle package article 45. The labeled bottle package article 45 is an article with an opaque label 46 around the center of the article 43 shown in FIG. 5. It is assumed that Step S1 performed on the labeled bottle package article 45 allows the detection unit 11a to detect the opaque label 46 in the central portion as an article region A2a and detect a plurality of surrounding bottles as an article region A2b. Furthermore, it is assumed that Step S2 performed on the article region A2a and the article region A2b allows the identification unit 11b to identify the article type of the article region A2a as a flat article or an uneven article and identifies the article region A2b as a bottle package article.

Like the article region A2a and the article region A2b in FIG. 7, when a combination of different article types is a combination of one of a flat article and an uneven article, and a bottle package article, the article region A2a is circumferentially extended 360°, circular patterns are detected in an extended region A3 that is an article region extended from the article region A2a, and the number of circular patterns in the article region A2a (an article region before the extension) and the number of circular patterns in the extended region A3 are compared with each other. In the following comparative example, the number of circular patterns in the extended region A3 relative to the number of circular patterns in the article region A2a is calculated as the ratio of circles, but the comparison is not limited thereto.

When the ratio of circles is large, that is, when the number of circular patterns in the extended region A3 is larger than the number of circular patterns in the article region A2a, bottle caps are likely to be placed around the article region A2a, so that the article region A2a and the article region A2b are likely to include a labeled bottle package article. Therefore, in this case, the confidence calculation unit 11c calculates the identical article probability of the article region A2a and the article region A2a so as to be higher than the predetermined value.

In contrast, when the ratio of circles is small, that is, when the number of circular patterns in the extended region A3 is equal to or smaller than the number of circular patterns in the article region A2a, the article region A2a and the article region A2b are likely to represent different articles. Hence, in this case, the confidence calculation unit 11c calculates the identical article probability of the article region A2a and the article region A2a so as to be lower than the predetermined value.

### <<Step S4>>

In Step S4, the confidence calculation unit 11c calculates the probability of presence of an article boundary between adjacent article regions as article boundary presence probability on the basis of the article types of the adjacent article regions. Optimum article boundary determination methods for calculating the article boundary presence probability vary among article types. Thus, the confidence calculation unit 11c selects an optimum article boundary determination method for each article region on the basis of the article types of the adjacent article regions, the article types being identified in Step S2. The confidence calculation unit 11c then calculates the probability of presence of an article boundary from the shape feature or the color feature in the image as an article boundary presence probability on the basis of the selected article boundary determination method. Referring to FIGS. 8 to 10, the article boundary determination method according to the article type of an article region will be described below.

FIG. 8 shows an example in which a flat article is detected as two article regions. Specifically, the article 41 that is originally one article is detected as two article regions A4a and A4b. It is assumed that the article types of the article regions A4a and A4b are identified as flat articles according to the shape features in the image.

When the article types of the adjacent article regions are flat articles like the article regions A4a and A4b, the confidence calculation unit 11c determines the presence or absence of a straight line between the adjacent article regions on the basis of the color feature in the image. When determining that both of a straight line and a recessed portion are present between the adjacent article regions, the confidence calculation unit 11c calculates the identical article probability to be higher than the predetermined value.

For example, in the case of FIG. 8, it is assumed that the confidence calculation unit 11c determines the presence of a straight line L1, which may serve as an article boundary, between the article region A4a and the article region A4b, on the basis of the color feature of the article 41, for example, the pattern of the article surface.

However, the straight line L1 may be a false article boundary present in the article 41. Thus, between the article region A4a and the article region A4b, it is determined whether a recessed portion is present between the article region A4a and the article region A4b on the basis of a shape feature such as a curvature in the image, and it is determined whether the straight line L1 is a true article boundary. The article boundary determination is based on the fact that both of a straight line and a vertically recessed portion are frequently present between article regions in an image when an article boundary is actually present between the adjacent article regions.

In FIG. 8, the article 41 is present between the article region A4a and the article region A4b and only a few uneven portions are present between the article region A4a and the article region A4b. Thus, the confidence calculation unit 11c determines that recessed portions are not present. In this case, the confidence calculation unit 11c determines that the straight line L1 is present but determines that recessed portions are not present. Thus, the confidence calculation unit 11c calculates the article boundary presence probability to be lower than a predetermined value. The predetermined value used for calculating the article boundary presence probability is 50%, which is the same as the predetermined value used for calculating the identical article probability. The predetermined value may be a different value from the predetermined value used for calculating the identical article probability.

FIG. 9 shows an example in which an uneven article is detected as two article regions. Specifically, the article 42 that is originally one article is detected as an article region A5a and an article region A5b. It is assumed that the article types of the article regions A5a and A5b are both identified as uneven articles from the feature characteristics in the image.

When the article types of adjacent article regions are both uneven articles like the article regions A5a and A5b, the confidence calculation unit 11c determines the presence or absence of a straight line between the adjacent article regions on the basis of the color features in the image, and determines the presence or absence of a recessed portion between the adjacent article regions on the basis of the shape features in the image. When determining that a straight line and a recessed portion are both present between the adjacent article regions, the confidence calculation unit 11c calculates the article boundary presence probability of the article region A4a and the article region A4b to be higher than the predetermined value.

For example, in the case of FIG. 9, it is assumed that the confidence calculation unit 11c determines the presence of a groove D, which may serve as an article boundary, between the article region A5a and the article region A5b on the basis of the shape feature in the image. Meanwhile, it is assumed that the confidence calculation unit 11c determines the absence of a straight line, which may serve as an article boundary, between the article region A5a and the article region A5b on the basis of the color feature in the image. In this case, since the groove D is likely to be a false article boundary present in the article 42, the article boundary presence probability for the article region A5a and the article region A5b is calculated to be lower than the predetermined value.

The detection unit 11a may perform, in Step S3, one or both of the process of determining the presence or absence of a straight line between adjacent article regions on the basis of the color feature in the image and the process of determining the presence or absence of a recessed portion between adjacent regions on the basis of the shape feature in the image. Alternatively, one or both of the processes may be performed in advance by the detection unit 11a in Step S1.

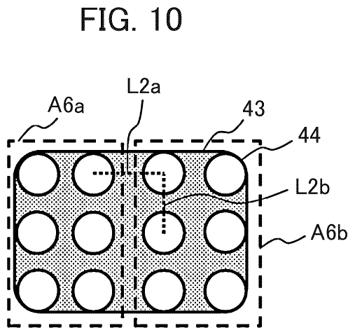

FIG. 10 shows an example in which a bottle package article is detected as two article regions. Specifically, the article 43 that is originally one article is detected as an article region A6a and an article region A6b. It is assumed that the article types of the article region A6a and the article region A6b are identified as bottle package articles from the color features in the image.

Since the cap portions 44 of bottles in the article 43 are wrapped in a package, the cap portions 44 are placed at equal intervals in the same bottle package article. When the two articles 43 are adjacent to each other, a distance between the cap portions 44 of adjacent bottles included in the different articles 43 is larger than a distance between the cap portions 44 in the same article 43 because of a gap or the thickness of the wrapping material between the articles 43.

When the article types of adjacent article regions are both bottle package articles like the article region A6a and the article region A6b, the confidence calculation unit 11c calculates an intra-region cap distance that represents a distance between the caps of adjacent bottles in one of the adjacent article regions and an inter-region cap distance that represents a distance between the caps of adjacent bottles included in different article regions, and calculates the article boundary presence probability to be lower than the predetermined value when the intra-region cap distance and the inter-region cap distance are equal to each other.

For example, as shown in FIG. 10, the inter-region cap distance is the length of a line segment L2a connecting the circle centers of the cap portions 44 of the article region A6a and the article region A6b, and the intra-region cap distance is the length of a line segment L2b connecting the circle centers of the cap portions 44 in the article region A6b. These distances are compared with each other to determine the presence or absence of an article boundary between the article region A6a and the article region A6b.

When the intra-region cap distance and the inter-region cap distance are equal to each other, the confidence calculation unit 11c calculates the article boundary presence probability to be lower than the predetermined value. A displacement to a certain degree may be considered in the determination of whether the intra-region cap distance and the inter-region cap distance are equal to each other. In FIG. 10, since the inter-region cap distance and the intra-region cap distance can be assumed to be equal to each other, the article boundary presence probability for the article region A6a and the article region A6b is calculated so as to be lower than the predetermined value.

### <<Step S5>>

In Step S5, the confidence calculation unit 11c calculates confidence on the basis of the identical article probability calculated in Step S3 and the article boundary presence probability calculated in Step S4. For example, the confidence is calculated on the basis of an equation: confidence=100%×(1−(identical article probability))×(article boundary presence probability). As described above, the identical article probability is the probability that adjacent article regions include the same article. When the identical article probability is high, it is highly likely that an article is erroneously detected as separate regions. In this case, a detected article region and an actual article region are less likely to be identical to each other. Thus, it is appropriate to set low confidence. Hence, the identical article probability is used in the form of “1−(identical article probability)” in the foregoing equation. The calculation of confidence using the equation is merely an example and is not limited thereto.

As described above, the present invention evaluates whether a detected article region and an actual article region are identical to each other. Even when articles are mixed on a pallet, the articles can be accurately identified.

### Second Embodiment

A second embodiment will describe an example in which the object recognition device 1 according to the first embodiment further optimize a recognition parameter. Hereinafter, differences from the first embodiment will be mainly described.

### <Optimization of Recognition Parameter>

The recognition parameter determines the degree of extraction of features on an image, the features being used when a detection unit 11a detects an article region in the image. For example, in the case where a curvature is used as a shape feature in the image, the shape feature is assumed to be a plane when the curvature is equal to or smaller than a certain threshold value.

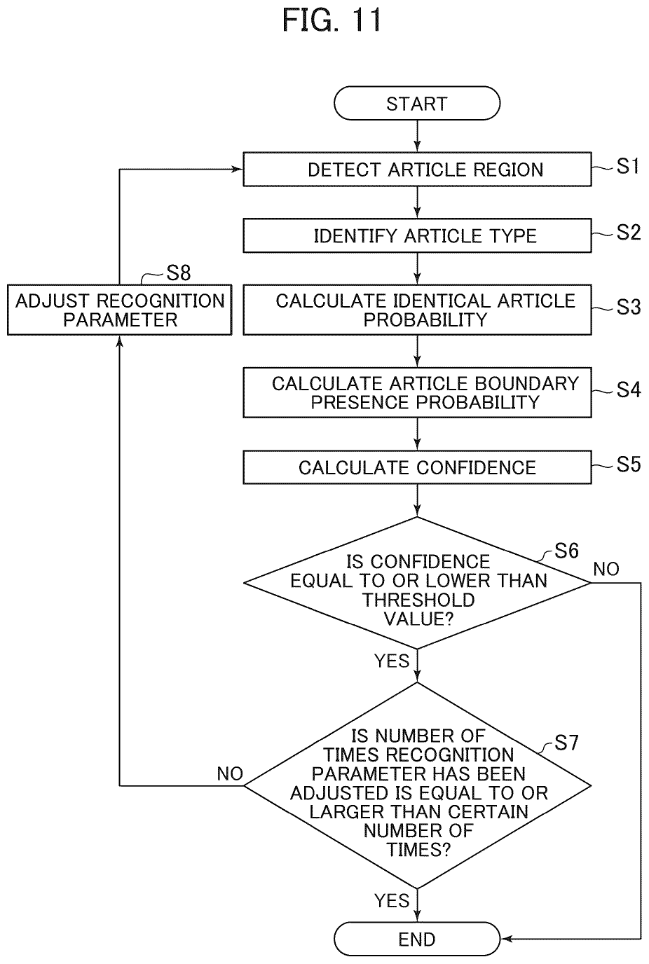

FIG. 11 is a flowchart showing optimization of the recognition parameter. Steps S1 to S5 are identical to those of FIG. 4. In Step S6, a confidence calculation unit 11c compares the value of confidence calculated in Step S5 with a predetermined threshold value and determines whether adjustment of the recognition parameter is required or not. If the confidence is greater than the threshold value, an article region detected in Step S2 is determined to be correct, so that the flowchart is terminated. If the confidence is equal to or lower than the threshold value, the confidence calculation unit 11c determines whether the number of times the recognition parameter has been adjusted is equal to or larger than a certain number of times. If the number of times the recognition parameter has been adjusted is equal to or larger than a certain number of times, it is determined that the result of the article region is not changed by an additional adjustment of the recognition parameter. The flowchart is then terminated. If the number of times the recognition parameter has been adjusted is smaller than a certain number of times, the confidence calculation unit 11c performs Step S8, that is, an adjustment to the recognition parameter. After the adjustment to the recognition parameter in Step S8, Steps S1 to S5 are performed again. The confidence may be increased by adjusting the recognition parameter to change the detection result of the article region, and thus Steps S6 and S7 are performed again.

By adjusting the recognition parameter thus, the detection accuracy of the article region can be adjusted.

### Third Embodiment

A third embodiment will describe an example in which the object recognition device 1 according to the first embodiment causes a robot 2 to make a slight displacement. Hereinafter, differences from the first embodiment will be mainly described.

### <Slight Displacement>

A slight displacement is a motion for changing the arrangement of articles 4 on a pallet 5 to easily detect an article region. A slight displacement is implemented by causing the robot 2 to hold one end of the article 4 and move the article 4 for a certain distance on the pallet 5 on the basis of a command from the object recognition device 1.

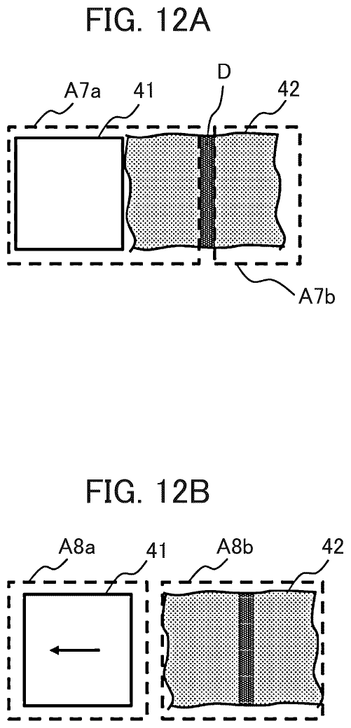

FIG. 12A shows an example of the article arrangement before a slight displacement is made. FIG. 12B shows an example of the article arrangement after the slight displacement is made. Before the slight displacement is made, as shown in FIG. 12A, an article 41 and an article 42 are placed in contact with each other. In this example, an article region A7a and an article region A7b are recognized with a groove D serving as an article boundary. However, the article boundary is different from an actual article boundary (a boundary between the article 41 and the article 42) and thus the recognition is false. In such a case, a displacement is made to change the arrangement in a direction that moves the article 41 away from the article 42 as shown in FIG. 12B. This can divide the region at a proper article boundary into an article region A8a and an article region A8b.

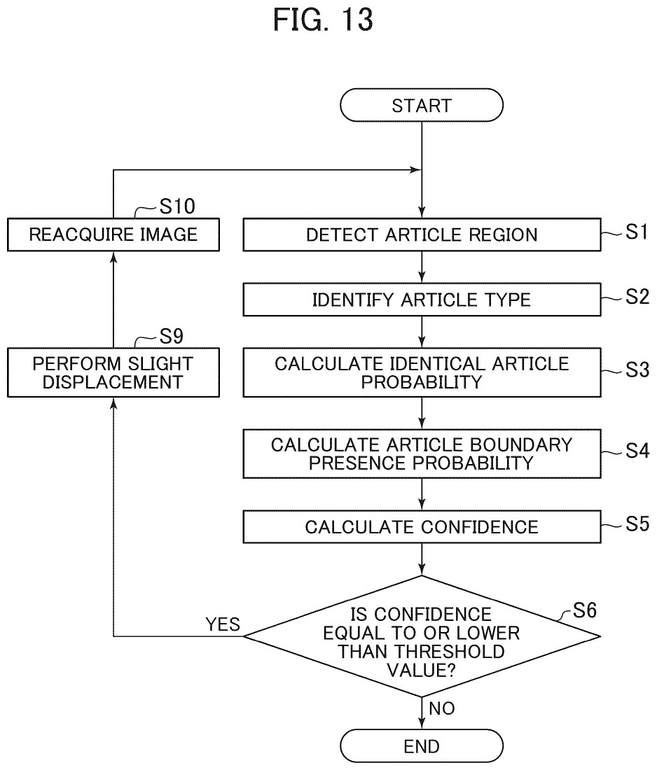

FIG. 13 is a flowchart showing a slight displacement. Steps S1 to S5 are identical to those of FIG. 4. In addition, FIG. 13 shows Step S10. Step S10 is a step in which a camera 3 captures an image of the articles 4 placed on the pallet 5 from above and an input unit 15a reacquires the image from the camera 3. In the present embodiment, the camera 3 captures images at regular intervals and the input unit 15a acquires the latest image according to the imaging period of the camera 3. The step is not limited thereto.

For example, the camera 3 may capture an image on the basis of an instruction from the object recognition device 1.

In Step S6, a confidence calculation unit 11c determines whether the confidence is equal to or lower than a threshold value. If the confidence is equal to or lower than the threshold value, the robot 2 is caused to make a slight displacement in Step S9. Specifically, in Step S9, the confidence calculation unit 11c generates a command of a slight displacement, and an output unit 15b outputs the command of the slight displacement to the robot 2. This causes the robot 2 to make the slight displacement. Thereafter, in Step S10, an image on the pallet 5 is reacquired in the input unit 15a after the slight displacement is made. Steps S1 to S5 are then performed using the reacquired image. Note that in Step S1 after the slight displacement is made, on the basis of the shape feature in an image, a detection unit 11a desirably detects an article region in a region rearranged by the slight displacement. This is because the slight displacement is likely to affect the shape feature more than the color feature in the image.

The confidence may be increased according to the detection result changed by the slight displacement. Thus, Step S6 is performed again.

The slight displacement may be made along with the optimization of a recognition parameter. For example, if the recognition result is not improved by adjusting the recognition parameter in Step S7 shown in FIG. 11, a slight displacement may be made as in Step S9 shown in FIG. 9.

As described above, the slight displacement of the present embodiment can divide a region at a proper article boundary.

### Fourth Embodiment

The present embodiment will describe an example in which a transfer robot system includes a display unit. The display unit is provided as, for example, a display screen or the like on an object recognition device 1. Alternatively, the display unit may be provided as a display screen or the like on a robot 2. In addition, the display unit may be provided as a display device for a display or a portable terminal to be connected to the object recognition device 1.

The display unit displays the confidence calculated by a confidence calculation unit 11c. At that time, the display unit displays an article region and the confidence that are superimposed on an image captured by a camera 3.

The transfer robot system including the display unit allows a robot administrator to recognize the confidence that represents the accuracy of detection of an article region by a detection unit. Thus, for example, the robot administrator can perform an operation for improving the confidence, for example, the robot administrator can displace an article in an article region having low confidence.

### LIST OF REFERENCE SIGNS

1: Object recognition device
11: Processor
11a: Detection unit
11b: Identification unit
11c: Confidence calculation unit
12: Memory
12a: Object recognition processing program
13: Input device
14: Output device
15: Communication interface
15a: Input unit
15b: Output unit
16: Bus
2: Robot
21: Articulated arm
22: Hand
3: Camera
3L: Left camera
3R: Right camera
4: Article
5: Pallet
41,42,43: Article
44: Cap portion of bottle
45: Labeled bottle package article
46: Opaque label
A1,A2,A4,A5,A6,A7,A8: Article region
A3: Extended region
L1: Straight line
D: Groove
L2: Line segment

1. An object recognition device that recognizes an article region in an image captured by a camera, the object recognition device comprising:
an input unit that acquires the image;
a detection unit that detects the article region in the image and acquires position/orientation information on an article;
an identification unit that identifies an article type of the article region by using a color feature or a shape feature of the article region;
a confidence calculation unit that compares the article types of the adjacent article regions and calculates confidence indicating accuracy of detection of the article region; and
an output unit that outputs, to a robot, a motion command on the basis of the position/orientation information on the article and the confidence.

2. The object recognition device according to claim 1, wherein
the confidence calculation unit
compares the article types of the adjacent article regions and calculates, as identical article probability, probability that the adjacent article regions contain the same article,
calculates probability of presence of an article boundary between the adjacent article regions as article boundary presence probability on the basis of the article types of the adjacent article regions, and
calculates the confidence on the basis of the identical article probability and the article boundary presence probability.

3. The object recognition device according to claim 2, wherein
when a combination of the article types of the adjacent article regions is identical to a combination preset as a combination of the article types that are likely to contain the same article, the confidence calculation unit calculates the identical article probability to be higher than a predetermined value.

4. The object recognition device according to claim 3, wherein
when the adjacent article regions have the same article type, the confidence calculation unit calculates the identical article probability to be higher than a predetermined value, and
when the adjacent article regions have different article types, the confidence calculation unit calculates the identical article probability according to a combination of the different article types.

5. The object recognition device according to claim 4, wherein
when the combination of the different article types is a combination of a flat article including many flat surfaces and an uneven article including many uneven portions, the confidence calculation unit calculates the identical article probability to be lower than the predetermined value,
when the combination of the different article types is a combination of one of the flat article and the uneven article and a bottle package article, the confidence calculation unit extends an article region identified as the flat article or the uneven article,
when the number of circular patterns in the extended article region is larger than the number of circular patterns in the article region before the extension, the confidence calculation unit calculates the identical article probability to be higher than the predetermined value, and
when the number of circular patterns in the extended article region is equal to or smaller than the number of circular patterns in the article region before the extension, the confidence calculation unit calculates the identical article probability to be lower than the predetermined value.

6. The object recognition device according to claim 2, wherein
when the article types of the adjacent article regions are flat articles containing many flat surfaces, the confidence calculation unit determines presence or absence of a straight line between the adjacent article regions on the basis of a color feature in the image, and determines presence or absence of a recessed portion between the adjacent article regions on the basis of a shape feature in the image, and when the confidence calculation unit determines that the straight line and the recessed portion are both present, the confidence calculation unit calculates the article boundary presence probability to be higher than a predetermined value.

7. The object recognition device according to claim 2, wherein
when the article types of the adjacent article regions are uneven articles containing many uneven portions, the confidence calculation unit determines presence or absence of a straight line between the adjacent article regions on the basis of a color feature in the image, and determines presence or absence of a recessed portion between the adjacent article regions on the basis of a shape feature in the image, and when the confidence calculation unit determines that the straight line and the recessed portion are both present, the confidence calculation unit calculates the article boundary presence probability to be higher than a predetermined value.

8. The object recognition device according to claim 2, wherein
when the article types of the adjacent article regions are bottle package articles, the confidence calculation unit calculates an intra-region cap distance that represents a distance between cap portions of adjacent bottles in one of the adjacent article regions and an inter-region cap distance that represents a distance between cap portions of adjacent bottles included in the different article regions, and
calculates the article boundary presence probability to be lower than a predetermined value when the intra-region cap distance and the inter-region cap distance are equal to each other.

9. The object recognition device according to claim 1, wherein
when the confidence is equal to or lower than a threshold value, the confidence calculation unit adjusts a recognition parameter for determining a degree of extraction of a feature on the image, the feature being used when the detection unit detects an article region in the image, and
the detection unit detects an article region in the image by using the adjusted recognition parameter.

10. The object recognition device according to claim 1, wherein
when the confidence is equal to or lower than a threshold value, the confidence calculation unit generates a command of a slight displacement for changing an arrangement of the article, and
the output unit outputs the command of the slight displacement to the robot.

11. An object recognition method that recognizes an article region in an image captured by a camera, the object recognition method comprising the steps of:
acquiring the image;
detecting the article region in the image and acquiring position/orientation information on an article;
identifying an article type of the article region by using a color feature or a shape feature of the article region; and
comparing the article types of the adjacent article regions and calculating confidence indicating accuracy of detection of the article region.

12. A transfer robot system comprising an object recognition device, a robot, and a camera, the object recognition device comprising:
an input unit that acquires an image captured by the camera;
a detection unit that detects an article region in the image and acquires position/orientation information on an article;
an identification unit that identifies an article type of the article region by using a color feature or a shape feature of the article region;
a confidence calculation unit that compares the article types of the adjacent article regions and calculates confidence indicating accuracy of detection of the article region; and
an output unit that outputs, to the robot, a motion command on the basis of the position/orientation information on the article and the confidence, wherein
the robot operates on the basis of the motion command.

13. The transfer robot system according to claim 12, further comprising
a display unit that displays the confidence.
